(19) United States
(12) Patent Application Publication
(10) Pub. No.: US 2008/0177926 A1
(43) Pub. Date: Jul. 24, 2008

(54) Log memory access circuit, information processing apparatus

(75) Inventor: Kohei Minami, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/984,113

(22) Filed: Nov. 13, 2007

(30) Foreign Application Priority Data
Jan. 18, 2007 (JP) 2007-009370

(51) Int. Cl. G06F 3/00

(52) U.S. Cl. 710/316

(57) ABSTRACT

A log-memory access circuit includes a log memory that stores a log; a connection-channel switching unit that switches between a first connection channel that connects a first access apparatus for accessing the log memory and the log memory and a second connection channel that connects a second access apparatus for accessing the log memory and the log memory; a switch input unit that inputs a switching instruction; a switch instruction unit that issues an instruction for switching between the first connection channel and the second connection channel to the connection-channel switching unit, in response to the input switching instruction; a first power supply unit that supplies power from-the first access apparatus to the individual units; and a second power supply unit that supplies power from the second access apparatus to the individual units, when the power of the first power supply unit is turned off.

### BACKGROUND OF THE INVENTION

1. Field of the Invention

The present invention relates to a log-memory access circuit for obtaining a log for maintenance, an information processing apparatus, and a log obtaining system for the information processing apparatus.

2. Description of the Related Art

FIGS. 1A and 1B are block diagrams of known log obtaining systems. A log of an information processing apparatus 51 is typically stored in a memory 52 that can be controlled by an MPU (micro processing unit) 53 provided in the information processing apparatus 51. In this case, as a method for a maintenance person to obtain the log from the memory 52, as shown in FIG. 1A, the information processing apparatus 51 and a log obtaining apparatus 61 for obtaining the log (e.g., a personal computer for maintenance) are connected through a network via a LAN (local area network) connector 54, and the log is downloaded from the information processing apparatus 51 to the log obtaining apparatus 61. As shown in FIG. 1B, a portable medium 55 (such as a USB memory) can be used as log storage location for the log obtaining system, when obtaining the log, the portable medium 55 is removed from the information processing apparatus 51, and the PC (personal computer) for maintenance is used to access a memory 52 within the portable medium 55.

### SUMMARY OF THE INVENTION

According to an aspect of an embodiment, a log-memory access circuit is connected to a first access apparatus and a second access apparatus. The log-memory access circuit includes a log memory for storing a log, a connection-channel switching unit for switching between a first connection channel for connecting the log memory to the first access apparatus for accessing the log memory and a second connection channel for connecting the log memory to the second access apparatus for accessing the log memory, a switch input unit for inputting a switching instruction, a switch instruction unit for issuing an instruction for switching between the first connection channel and the second connection channel to the connection-channel switching unit, in response to the input switching instruction, a first power supply unit for supplying power from the first access apparatus to the individual units, and a second power supply unit for supplying power from the second access apparatus to the individual units upon the power of the first power supply unit being turned off.

### BRIEF DESCRIPTION OF THE DRAWINGS

FIGS. 1A and 1B are block diagrams of known log obtaining systems according to a prior art;

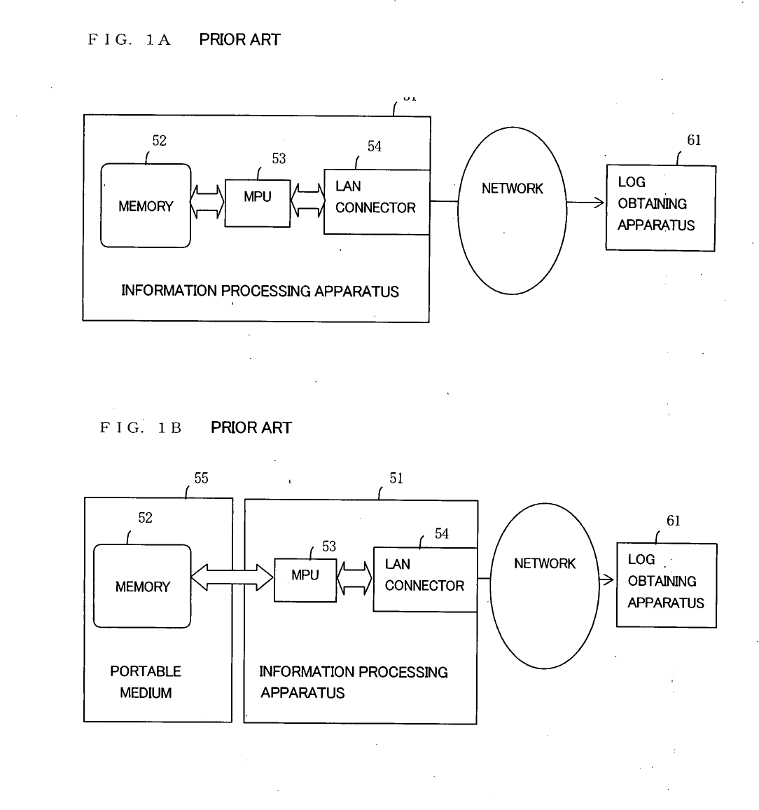

FIG. 2 is a block diagram of a log-memory access circuit;

FIG. 3 is a diagram illustrating a power supply circuit;

FIG. 4 is a block diagram showing of a log obtaining system of a first embodiment;

FIG. 5 is a flowchart of processing of the log obtaining system shown in FIG. 4;

FIG. 6 is a first log-flow diagram;

FIG. 7 is a second log-flow diagram;

FIG. 8 is a block diagram of a log obtaining system of a second embodiment;

FIG. 9 is a flowchart of processing of the log obtaining system shown in FIG. 8;

FIG. 10 is a block diagram of a log obtaining system of a third embodiment; and

FIG. 11 is a flowchart of processing of the log obtaining system shown in FIG. 10.

### DESCRIPTION OF THE PREFERRED EMBODIMENTS

### First Embodiment

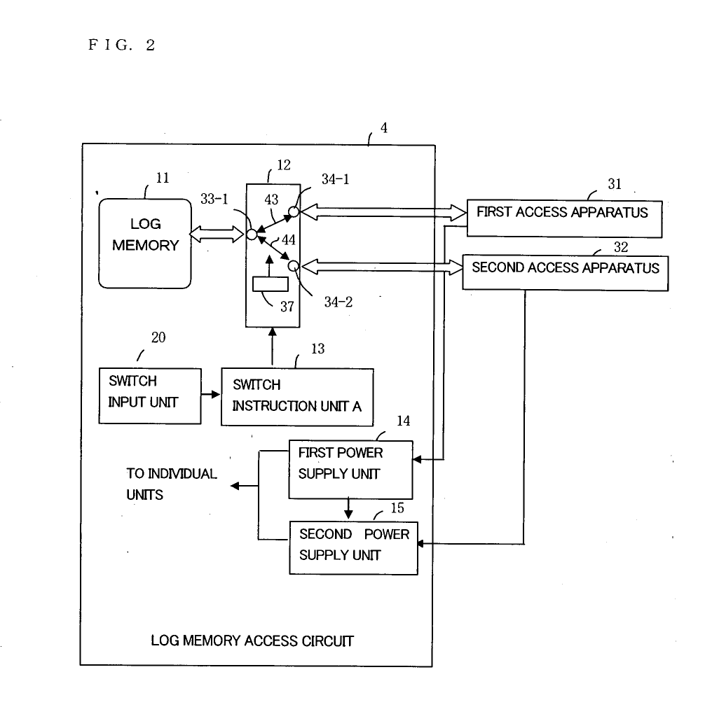

FIG. 2 is a block diagram of a log-memory access circuit.

A log-memory access circuit 4 is connected to a first access apparatus 31 and a second access apparatus 32.

The first access apparatus 31 is, for example, an information processing apparatus for implementing the log-memory access circuit 4 and has a USB (universal serial bus) controller for accessing the log-memory access circuit 4. The first access apparatus 31 reads/writes a log from/to a log memory 11 included in the log-memory access circuit 4. The log is, for example, a log required for maintenance for various errors and so on of the first access apparatus 31.

The second access apparatus 32 is a personal computer for maintenance, has an USB interface, and reads a log from the log memory 11 included in the log-memory access circuit 4.

The log-memory access circuit 4 has the log memory 11, a USB switching hub A 12 (denoted by HUBA in FIG. 2), a switch instruction unit A 13, a first power supply unit 14, a second power supply unit 15, and a switch input unit 20. The log-memory access circuit 4, is provided on, for example, an optional substrate included in and fixed to the first access apparatus 31. The log memory 11 is, for example, a flash ROM (read only memory) and has a USB controller therein. In FIG. 2, the log memory 11 is not a portable medium and thus is not removable from the substrate. The log memory 11 may be soldered to the substrate. The reason the log memory 11 is not a portable medium, or is soldered to the substrate is to enhance the security.

The USB switching hub A 12 is a dedicated LSI (large scale integrated) hub, and has a downstream port 33-1, two upstream ports 34-1 and 34-2, a port selector, and a hub controller. The downstream port 33-1 of the USB switching hub A 12 is connected to the log memory 11. The upstream port 34-1 of the USB switching hub A 12 is connected to the first access apparatus 31. The upstream port 34-2 of the USB switching hub A 12 is connected to the second access apparatus 32.

In accordance with an instruction from the switch instruction unit A 13, the port selector switches between a connection channel A 43 that connects the downstream port 33-1 and the upstream port 34-1, and a connection channel B 44 that connects the downstream port 33-1 and the upstream port 34-2.

A hub controller 37 controls USB communication between the log memory 11 and the first access apparatus 31 and the log memory 11 and the second access apparatus 32.

The switch instruction unit A 13 switches the USB switching hub A 12 between the connection channel A 43 and the connection channel B 44. The connection channel A 43 is used when the first access apparatus 31 writes/reads a log to/from the log memory 11. The connection channel B 44 is used when the second access apparatus 32 accesses the log memory 11. For example, two external pins P1 and P2 of a LSI contains the USB switching hub A 12 are “0” and “1” respectively, the log memory 11 and the first access apparatus 31 are connected via the connection channel A 43. When the external pins P1 and P2 are “1” and “0” respectively, the log memory 11 and the second access apparatus 32 are connected via the connection channel B 44. Thus, the switch instruction unit A 13 outputs a corresponding switching signal, in accordance with a switching instruction from the switch input unit 20.

For example, when a switching instruction input is “0”, signals “0” and “1” for selecting the connection channel A 43 are output to the switching pins P1 and P2. When the switching instruction input is “1”, signals “1” and “0” for selecting the connection channel B 44 are output to the switching pins P1 and P2.

The switch input unit 20 issues a switching instruction to the switch instruction unit A 13. The switch input unit 20 is, for example, an external terminal. The switching instruction is issued by a setting of the external terminal. This external terminal may be a switch. For example, when the switch is turned on, “0” is output from the switch input unit 20, and when the switch is turned off, “1” is output from the switch input unit 20.

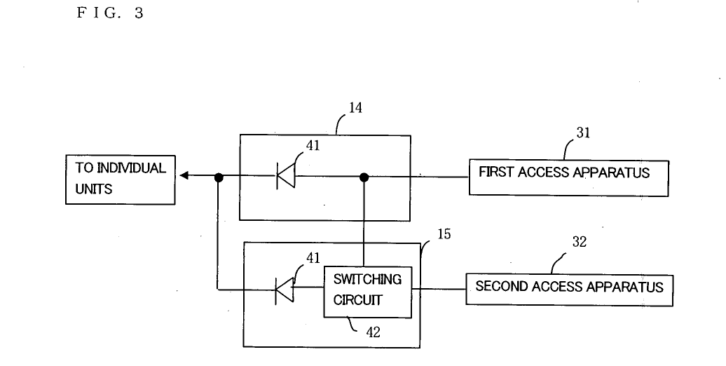

FIG. 3 is a diagram illustrating a power supply circuit.

The first power supply unit 14 is a circuit that supplies a 5V power voltage, fed from the first access apparatus 31, to the log memory 11, the USB switching hub A 12, the switch instruction unit A 13, and the switch input unit 20. The first power supply unit 14 outputs 5V to the individual units via a backflow prevention diode 41.

The second power supply unit 15 uses VBUS bus power supplied from the second access apparatus 32. That is, upon receiving 5V VBUS of the USB interface, the second power supply unit 15 outputs 5V to the log memory 11, the USB switching hub A 12, the switch instruction unit 13, and the switch input unit 20 via a switching circuit 42 and a backflow prevention diode 41.

The on/off condition of the switching circuit 42 is that, when the power from the first power supply unit 14 is input to the second power supply unit 15, the switching circuit 42 is switched off and thus the power is not output to the individual units from the second power supply unit 15. When the power from the first power supply unit 14 is not input to the second power supply unit 15, the switching circuit 42 is switched on and thus the power is output to the individual units from the second power supply unit 15.

As a result, when the power system of the first power supply unit 14 fails, the power can be supplied to the log-memory access circuit 4 by the VBUS bus power of the second access apparatus 32 connected to the upstream port 34-2.

The first power supply unit 14 and the second power supply unit 15 uses wired-OR to supply the power to the log memory 11, the USB switching hub A 12, the switch instruction unit A 13, and the switch input unit 20.

As a result, even if the first access apparatus 31 cannot access the log memory 11, the second access apparatus 32 is connected to the log-memory access circuit 4 and the setting of the switch instruction unit A 13 is changed to the connection channel B 44, so that the contents of the log memory 11 can be accessed.

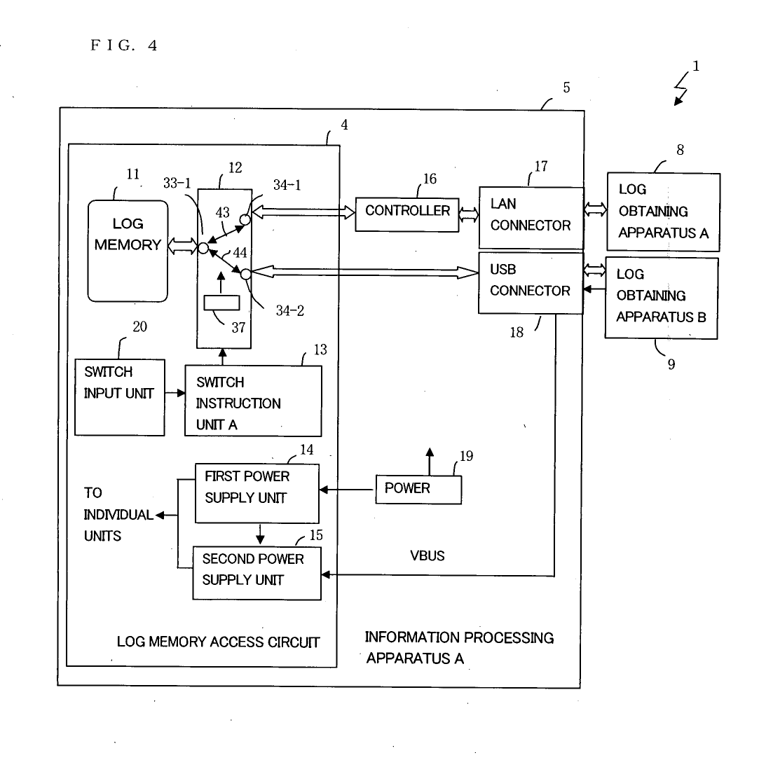

FIG. 4 is a block diagram of a log obtaining system of first embodiment.

A log obtaining system 1 shown in FIG. 4 includes an information processing apparatus A 5, a log obtaining apparatus A 8, and a log obtaining apparatus B 9.

The information processing apparatus A 5 may be a server computer or the like and has a log-memory access circuit 4, a controller 16, a LAN (local area network) connector 17, a USB connector 18, and a power supply 19.

The log obtaining apparatus A 8 and the log obtaining apparatus B 9 are, for example, personal computers for maintenance.

The log-memory access circuit 4 has the same configuration as described above.

The controller 16 has an MPU or the like for controlling the information processing apparatus A 5, and also controls an input unit for inputting data, an output unit for outputting data, a memory for storing data (the units are not shown), and so on. The controller 16 further includes a USB controller for controlling the USB switching hub A 12 in accordance with a USB protocol, and a LAN controller for controlling a LAN.

The LAN connector 17 provides a LAN connection between the log obtaining apparatus A 8 for obtaining a log via the network or a printer for outputting print data from the information processing apparatus A 5.

The USB connector 18 is used to connect the log obtaining apparatus B 9 to the information processing apparatus A 5. The log obtaining apparatus B 9 supplies VBUS of a power-supply line from the USB connector 18 to the information processing apparatus A 5.

The power supply 19 supplies a power of 5V or the like to the individual units of the information processing apparatus A 5.

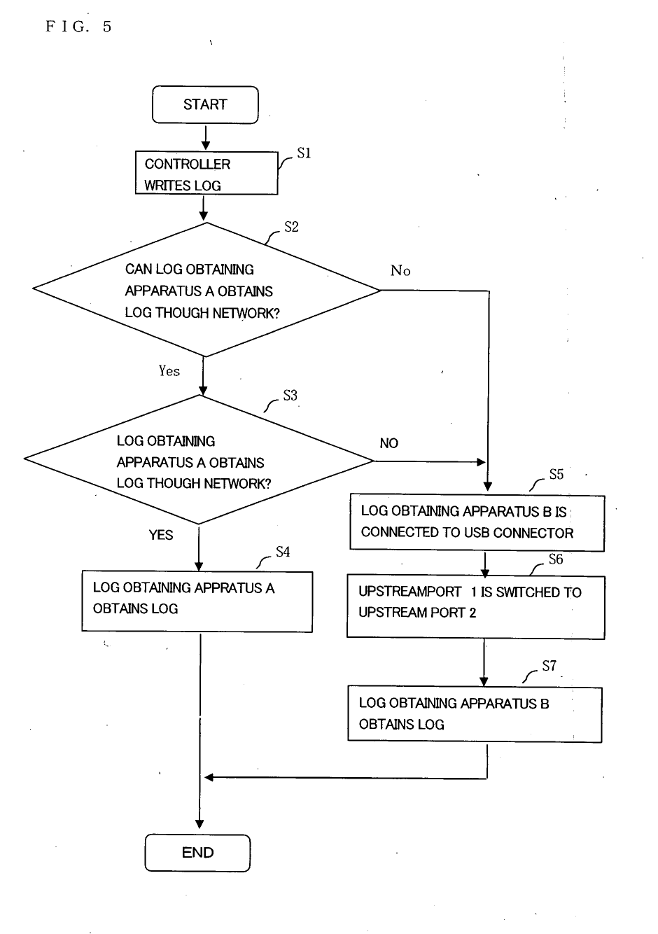

FIG. 5 is a flowchart of processing of the log obtaining system shown in FIG. 4.

The information processing apparatus A 5 is typically connected to a printer, the log obtaining apparatus A 8, and so on through the local area network via the controller 16. The log obtaining apparatus B 9 is not initially connected to the information processing apparatus A 5.

In step S1, a log is written from the controller 16 to the log memory 11 via the USB switching hub A 12.

Next, in step S2, it is determined whether or not the log obtaining apparatus A 8 can obtain a log through the network.

When it is a determined that a log can be obtained through the network, a determination is made in step S3 as to whether or not the log obtaining apparatus A 8 obtains the log through the network.

When the log is to be obtained through the network, the log obtaining apparatus A 8 obtains the log through the network in step S4.

The process of a case in which the log is obtained through the network will be described next.

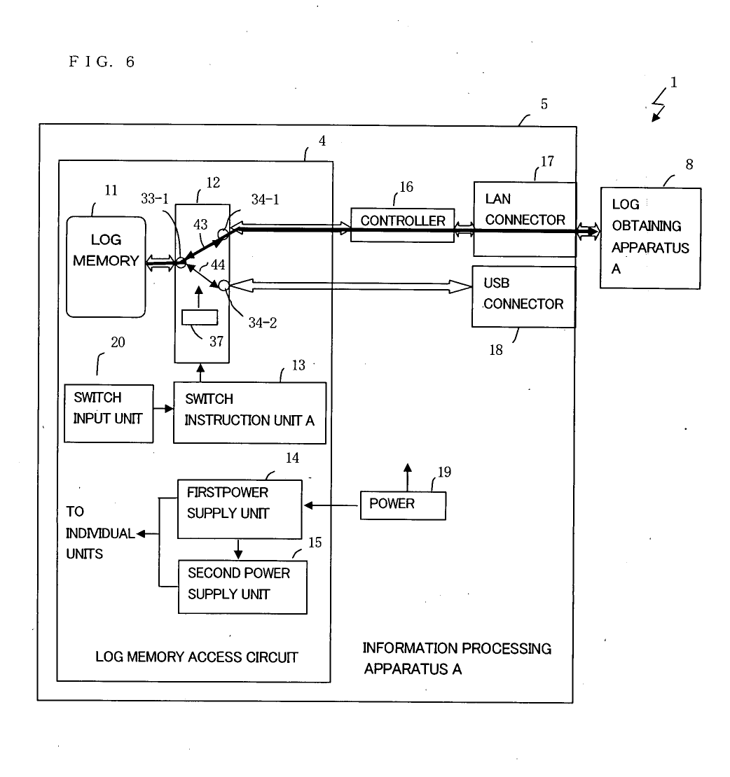

FIG. 6 is a first log-flow diagram.

When a log is obtained from the information processing apparatus A 5, a log obtaining request is sent from the log obtaining apparatus A 8 to the information processing apparatus A 5.

When the information processing apparatus A 5 receives the log obtaining request, the controller 16 obtains the log from the log memory 11 via the downstream port 33-1 and the upstream port 34-1 of the USB switching hub A 12.

Next, the controller 16 sends the obtained log to the log obtaining apparatus A 8 through the network via the LAN connector 17. As a result, the log obtaining apparatus A 8 can obtain the log.

A description will now be given with reference back to FIG. 5.

When it is desired to obtain a log at a site after maintenance work is performed thereat, or when communication between the information processing apparatus A 5 and the log obtaining apparatus A 8 through the network is not properly performed, the maintenance person obtains the log at the site where the information processing apparatus A 5 is placed.

In such a case, in step S5, the log obtaining apparatus B 9 is connected to the USB connector 18.

Next, the switch input unit 20 is switched off and the USB switching hub A 12 is switched from the upstream port 34-1 to the upstream port 34-2. As a result, in step S6, the connection channel for the upstream port of the USB switching hub A 12 is switched from the upstream port 34-1, which is connected to the controller 16, to the upstream port 34-2, which is connected to the log obtaining apparatus B 9. As a result, the log memory 11, in which the log is stored, is disconnected from the controller 16, and is connected to the log obtaining apparatus B 9. Thus, in step S7, the log obtaining apparatus B 9 can obtain the log from the log memory 11 via the USB switching hub A 12 in accordance with the USB protocol.

A process in a case in which a log is obtained via the USB connector 18 will be described next.

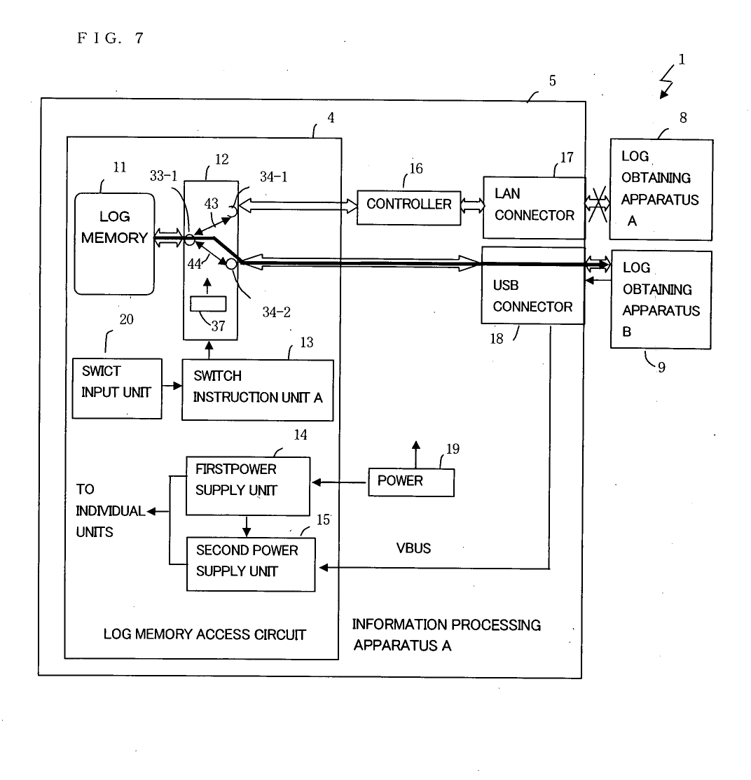

FIG. 7 is a second log-flow diagram.

A log-obtaining request is sent from the log obtaining apparatus B 9 to the information processing apparatus A 5.

When the USB switching hub A 12 in the information processing apparatus A 5 receives the log obtaining request from the log obtaining apparatus B 9, it transfers the log obtaining request to the log memory 11. The USB switching hub A 12 then sends a log, obtained from the log memory 11, to the log obtaining apparatus B 9 via the downstream port 33-1 and the upstream port 34-2.

In the system of the present embodiment, the information processing apparatus A 5 is connected to the log obtaining apparatus B 9, so that power is supplied from the log obtaining apparatus B 9 to the log memory 11, the USB switching hub A 12, the switch instruction unit A 13, and the switch input unit 20 via the USB connector 18. Thus, even if the power is not supplied to the information processing apparatus A 5 from the power supply 19 due to failure, the power is supplied to the log-memory access circuit 4 from the log obtaining apparatus B 9, and the log can be obtained.

### Second Embodiment

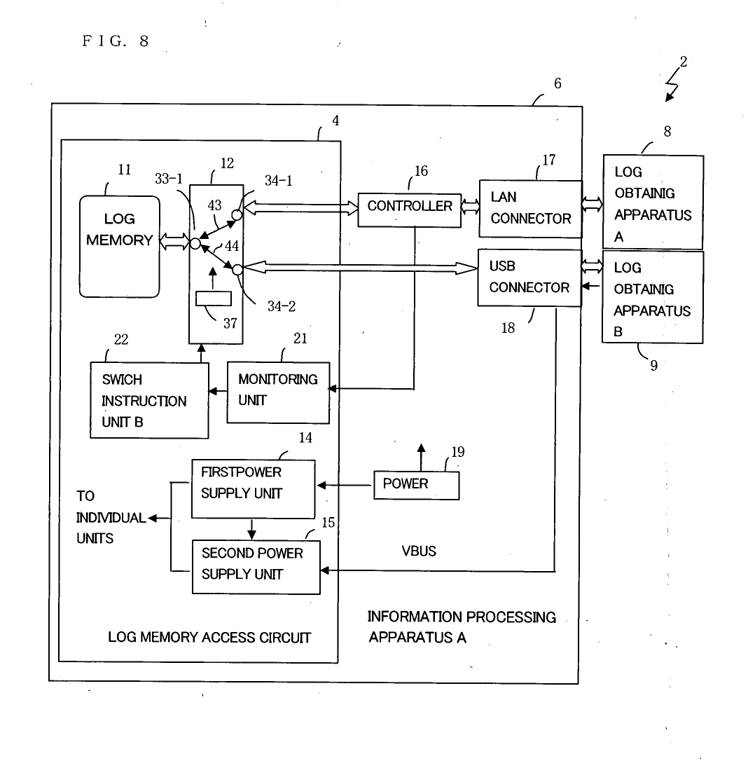

FIG. 8 is a block diagram of a log obtaining system of a second embodiment.

A log obtaining system 2 in FIG. 8 includes an information processing apparatus B6, a log obtaining apparatus A 8, and a log obtaining apparatus B 9.

The second embodiment is different from the first embodiment in that a monitoring unit 21 gives an instruction to a switch instruction unit B 22 instead of using the setting performed by the switch input unit 20.

The monitoring unit 21 monitors the operation of the controller 16. When the controller 16 fails, for example, when the controller 16 cannot perform network communicate due to a failure in the LAN circuit, for example, the monitoring unit 21 detects the failure.

A first method for detecting the failure is that, when the controller 16 detects a communication failure, the controller 16 issues a notification indicating so to the monitoring unit 21 for detection.

A second method for detecting the failure is that the monitoring unit 21 is provided with a watchdog timer and detects the expiry of the watchdog timer to detect runaway of the MPU of the controller 16.

Usually, the MPU resets the watchdog timer at regular intervals, but when the MPU runs away, the reset of the watchdog timer cannot be performed. Thus, the watchdog timer refers to a timer that expires.

When the monitoring unit 21 detects failure, it issues, to the switch instruction unit B 22, an instruction for switching the upstream port from the upstream port 34-1 to the upstream port 34-2. Upon receiving the instruction, the switch instruction unit B 22 outputs data “1” and “0” for switching from the upstream port 34-1 to the upstream port 34-2 to the ports P1 and P2 of the USB switching hub A 12, thereby switching the ports.

Unlike the first embodiment, the power from the first power supply unit 14 or the second power supply unit 15 is supplied to the monitoring unit 21, not the switch input unit 20.

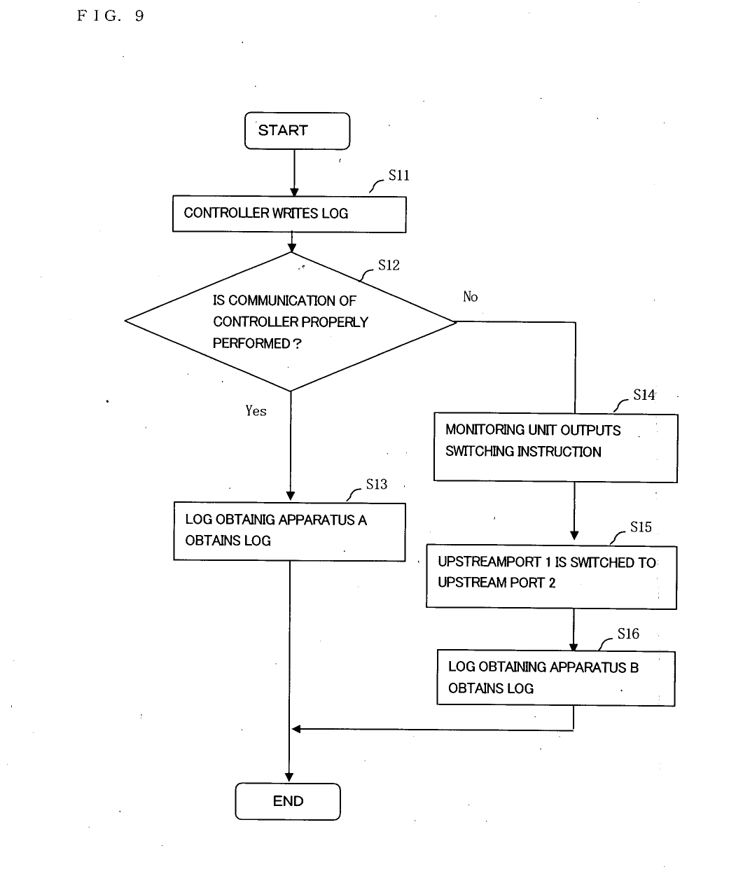

FIG. 9 is a flowchart of processing of the log obtaining system shown in FIG. 8.

The information processing apparatus B6 is typically connected to a printer and so on through the local area network via the controller 16. The log obtaining apparatus B 9 is connected to the information processing apparatus B6 in advance.

In step S11, a log is written from the controller 16 to the log memory 11 via the USB switching hub A 12.

Next, in step S12, the monitoring unit 21 checks whether or not communication of the controller 16 is properly performed.

When the controller 16 is properly communicating with the log obtaining apparatus A 8, the log obtaining apparatus A 8 obtains the log through the network in step S13.

On the other hand, when the monitoring unit 21 determines that the communication is not properly performed, the monitoring unit 21 outputs a switching instruction to the switch instruction unit B 22 in step S14.

Upon receiving the switching instruction, the switch instruction unit B 22 switches the upstream port of the USB switching hub A 12 from the upstream port 34-1 to the upstream port 34-2 in step S15.

As a result, the upstream port of the USB switching hub A 12 is switched from the port connected to the controller 16 to the port connected to the log obtaining apparatus B 9.

Consequently, the log memory 11, in which the log is stored, is disconnected from the controller 16 and is connected to the log obtaining apparatus B 9. Thus, in step S16, the log obtaining apparatus B 9 can obtain the log from the log memory 11 via the USB switching hub A 12.

### Third Embodiment

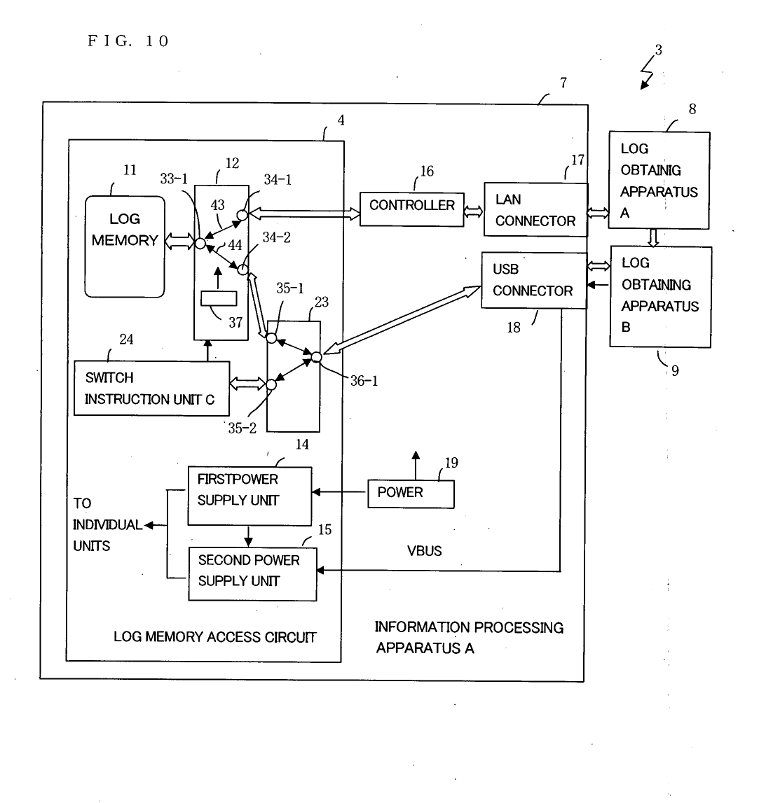

FIG. 10 is a block diagram of a log obtaining system of a third embodiment.

A log obtaining system 3 shown in FIG. 10 includes an information processing apparatus C7, a log obtaining apparatus A 8, and a log obtaining apparatus B 9.

The third embodiment is different from the first embodiment in that the log obtaining apparatus B 9 issues an instruction to a switch instruction unit C 24. The log obtaining apparatus A 8 issues, to the log obtaining apparatus B 9, a notification indicating the log obtaining apparatus A 8 can not obtain a log from the information processing apparatus C7. The log obtaining apparatus A 8 and the log obtaining apparatus B 9 are connected through a network.

Upon receiving the instruction, the log obtaining apparatus B 9 issues a switching instruction to the switch instruction unit C 24 in the log-memory access circuit 4.

The log-memory access circuit 4 includes a USB switching hub B 23 (denoted by “HUBB” in FIG. 10).

One of the upstream ports of the USB switching hub A 12 is connected to a unit that is different from the one in the first embodiment. That is, the upstream port 34-1 of the USB switching hub A 12 is connected to the controller 16 and is further connected to the log obtaining apparatus A 8 through the network. On the other hand, the upstream port 34-2 of the upstream interface of the USB switching hub A 12 is connected to the log obtaining apparatus B 9 via the USB switching hub B 23.

The USB switching hub B 23 is a dedicated LSI hub and has two downstream interfaces (downstream ports 35-1 and 35-2) and one upstream interface (an upstream port 36-1). The downstream port 35-1 of the USB switching hub B 23 is connected to the upstream port 34-2 of the USB switching hub A 12. The downstream port 35-2 of the USB switching hub B 23 is connected to the switch instruction unit C 24.

The upstream port 36-1 of the USB switching hub B 23 is connected to the log obtaining apparatus B 9 via the USB connector.

The switch instruction unit C 24 switches between two ports, i.e., the upstream port 34-1 and the upstream port 34-2 of the USB switching hub A 12. The upstream port 34-1 is included in a channel connected to the controller 16, when the controller 16 writes/reads a log to/from the log memory 11. The upstream port 34-2 is included in a channel connected from the log obtaining apparatus B 9 to the log memory 11. The switch instruction unit C 24 has a USB controller therein in order to communicate with the USB switching hub B 23. Unlike the first embodiment, the power from the first power supply unit 14 or the second power supply unit 15 is supplied to the USB switching hub B 23, not to the switch input unit 20.

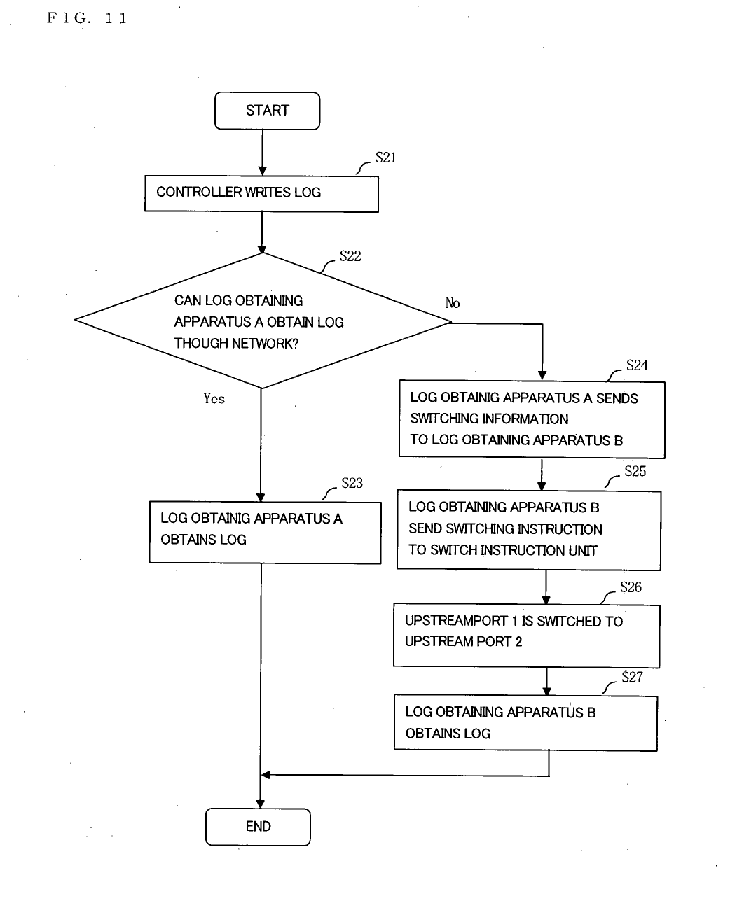

FIG. 11 is a flowchart of processing of the log obtaining system shown in FIG. 10.

The information processing apparatus C7 typically communicates with a printer and so on through the local area network via the controller 16. The log obtaining apparatus B 9 is connected to the information processing apparatus C7 in advance.

In step S21, a log is written from the controller 16 to the log memory 11 via the USB switching hub A 12.

Next, in step S22, a determination is made as to whether or not the log obtaining apparatus A 8 can obtain a log through the network.

When it is determined that communication with the log obtaining apparatus A 8 is properly performed and the log obtaining apparatus A 8 can obtain a log, the log obtaining apparatus A 8 obtains the log through the network in step S23.

On the other hand, when it is determined that the log cannot be obtained from the log memory 11 through the local area network due to a failure, the log obtaining apparatus A 8 sends a switching instruction for the USB switching hub A 12 to the log obtaining apparatus B 9 in step S24.

Upon receiving the switching instruction from the log obtaining apparatus A 8, the log obtaining apparatus B 9 sends a switching instruction to the switch instruction unit C 24 via the USB switching hub B 23 in step S25.

Upon receiving the switching instruction, the switch instruction unit C 24 switches the upstream port of the USB switching hub A 12 from the upstream port 34-1 to the upstream port 34-2 in step S26.

As a result, the connection channel of the upstream port of the USB switching hub A 12 is switched from the connection with the controller 16 to the connection with the USB switching hub B 23. Thus, the log memory 11, in which the log is stored, is disconnected from the controller 16 and is connected to the connection channel for the log obtaining apparatus B 9. Thus, in step S27, the log obtaining apparatus B 9 can obtain the log via the USB switching hub B 23.

The log-memory access circuit 4 may be provided with a dedicated controller so as to be connected to the log obtaining apparatus B 9 through a network. In such a case, since the log obtaining apparatus A 8 and the log obtaining apparatus B 9 can be placed at a maintenance center, switching between the apparatuses A 8 and A9 facilitates the maintenance.

What is claimed is:

1. A log-memory access circuit connected to a first access apparatus and a second access apparatus, said log-memory access circuit comprising:
a log memory for storing a log;
a connection-channel switching unit for switching between a first connection channel for connecting the log memory to the first access apparatus for accessing the log memory, and a second connection channel for connecting the log memory to the second access apparatus for accessing the log memory;
a switch instruction unit for issuing an instruction for switching between the first connection channel and the second connection channel to the connection-channel switching unit;
a first power supply unit for supplying power from the first access apparatus to the individual units; and
a second power supply unit for supplying power from the second access apparatus to the individual units upon the power of the first power supply unit being turned off.

2. The log-memory access circuit according to claim 1, wherein the connection-channel switching unit comprises a universal-serial-bus switching hub having a downstream port connected to the log memory, upstream ports connected to the first access apparatus and the second access apparatus respectively, and a port selector that switches the connection channels between the upstream port and the downstream port.

3. An information processing apparatus connected to a first log obtaining apparatus for accessing a log memory for a log and a second log obtaining apparatus for accessing the log memory for the log, the information processing apparatus comprising:
a controller connected to the first log obtaining apparatus, said controller accessing the log memory;
a connection unit connected to the second log obtaining apparatus for accessing the log memory;
a connection-channel switching unit for switching between a first connection channel for connecting the log memory to the controller, and a second connection channel for connecting the log memory to the connection unit;
a switch instruction unit for issuing an instruction for switching between the first connection channel and the second connection channel to the connection-channel switching unit;
a first power supply unit for supplying power to the individual units; and
a second power supply unit for supplying power from the second log obtaining apparatus to the individual units upon the power of the first power supply unit being turned off.

4. The information processing apparatus according to claim 3, wherein the switch input unit monitors failure of the controller and inputs, upon detecting failure, an instruction for switching from the first connection channel to the second connection channel to the switch instruction unit.

5. The information processing apparatus according to claim 3, wherein the connection-channel switching unit comprises a universal-serial-bus switching hub having a downstream port connected to the log memory, upstream ports connected to the first log obtaining apparatus and the second log obtaining apparatus, and a port selector for switching the connection channels between the upstream port and the downstream port.

6. An information processing apparatus connected to a first log obtaining apparatus for accessing a log memory for a log and a second log obtaining apparatus for accessing the log memory for the log, the information processing apparatus comprising:
a controller connected to the first log obtaining apparatus, said controller accessing the log memory;
a connection unit connected to the second log obtaining apparatus for accessing the log memory;
a connection-channel switching unit for switching between a first connection channel for connecting the log memory to the controller and a second connection channel for connecting the log memory to a connection controller;
the connection controller for inputting a switching instruction, sent from the second log obtaining apparatus connected to the connection unit, to a switch instruction unit, said the connection controller being connected to the second connection channel of the connection-channel switching unit;
the switch instruction unit for issuing an instruction for switching between the first connection channel and the second connection channel to the connection-channel switching unit, in response to the switching instruction;
a first power supply unit for supplying power to the individual units; and
a second power supply unit for supplying power, supplied from the second log obtaining apparatus, to the individual units upon the power of the first power supply being turned off.

7. The information processing apparatus according to claim 6, wherein the connection-channel switching unit comprises a universal-serial-bus switching hub having a downstream port connected to the log memory, two upstream ports connected to the first log obtaining apparatus and the second log obtaining apparatus, and a port selector for switching the connection channels between the upstream port and the downstream port.

8. The information processing apparatus according to claim 6, wherein the connection controller comprises a universal-serial-bus switching hub having a downstream port connected to the connection-channel switching unit, a downstream port connected to the switch instruction unit, and an upstream port connected to the connection unit.
